(19) United States
(12) Patent Application Publication
(10) Pub. No.: US 2011/0180340 A1
(43) Pub. Date: Jul. 28, 2011

(54) COMPRESSED GAS POWER DRIVE SYSTEM FOR A MOTOR VEHICLE AND METHOD THEREFOR

(76) Inventor: Leonard Wayne Peaslee, Phoenix, AZ (US)

(21) Appl. No.: 12/694,453

(22) Filed: Jan. 27, 2010

(51) Int. Cl. B60K 6/12; F16D 31/02

(52) U.S. Cl. 180/165; 60/413

(57) ABSTRACT

A system for propelling a vehicle has an enclosed turbine unit coupled to a transaxle of the vehicle. A storage tank is provided for holding a compressed gas. The compressed gas used to rotate a turbine of the turbine unit. A first compressor unit is coupled to an output of the enclosed turbine unit to repressurize the compressed gas used to rotate the turbine and to send the repressurize compressed gas back to an input of the storage tank.

### FIELD OF THE INVENTION

The present invention relates to a drive system for a motor vehicle and more specifically, to a compressed gas unit which drives a turbine that propels a motor vehicle.

### BACKGROUND OF THE INVENTION

In order to reduce the dependence on fossil fuels, alternative methods to drive motor vehicles need to be developed. One of the explored technologies is the use of electric motors in automobiles. Electric motors generally are powered by a DC power source such as a battery and do not require the use of gasoline or diesel fuel. One benefit of using electric motors is that they do not emit pollutants into the atmosphere since they do not burn fossil fuels. Electric motors provide a clean source of power to propel a motor vehicle.

One requirement of electric motors is the need for a large energy storage system to provide continuous power. One solution has been to use car batteries to power the electric motors. However, batteries have to be continuously recharged in order to fully power the electric vehicle. Car batteries also only have a limited number of times in which they may be recharged. Once a car battery can no longer be recharged, it must be disposed. Many people feel that disposing of the used car batteries may be a larger environmental problem than burning fossil fuels.

One solution to using batteries to power electric motors has been to use a flywheel. As compared to batteries, which have a limited number of charges before replacement, a flywheel will have an almost unlimited lifespan with proper maintenance, despite a large number of charge and discharge cycles. Furthermore, flywheels have a fast recharge time as compared to batteries. A large battery may take several hours to recharge, while a flywheel may take minutes. In addition, the flywheel is a clean source of power for the electric motor. As power is transferred to the motor, the flywheel also emits no pollutants, thereby, limiting harmful emissions into the atmosphere. Thus, a motor vehicle driven by a flywheel drive system containing electric motors provides a substantial benefit over drive systems using combustion engines.

While present flywheel systems for driving electric powered vehicles do currently work, they have several problems. First, most electric vehicles are limited as to the speed the vehicle may travel. Most electric vehicles are driven by a single electric motor. The power provided by a single electric motor is generally limited due to the weight of the vehicle. Furthermore, a single electric motor fails to provide sufficient power to satisfy most consumers. Most electric vehicles have a fairly slow acceleration rate when the driver presses on the gas pedal. Second, most flywheels are generally started by use of a battery. However, if the battery should fail, most flywheel systems have no back-up power supply to start the flywheel.

Therefore, a need existed to provide a system and method to overcome the above problem.

### SUMMARY OF THE INVENTION

In accordance with one embodiment, a system for propelling a vehicle has an enclosed turbine unit coupled to a transaxle of the vehicle. A storage tank is provided for holding a compressed gas. The compressed gas used to rotate a turbine of the turbine unit. A first compressor unit is coupled to an output of the enclosed turbine unit to repressurize the compressed gas used to rotate the turbine and to send the repressurize compressed gas back to an input of the storage tank.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a top view of the compressed gas powered drive system attached to a transmission of a vehicle;

FIG. 2 is a simplified block diagram of the compressed gas powered drive system of the present invention;

FIG. 3 is a side view of a turbine used in the compressed gas powered drive system of the present invention; and

FIG. 4 is a front view of a turbine used in the compressed gas powered drive system of the present invention

FIG. 5 is an exploded view of the turbine of FIG. 3.

### DETAILED DESCRIPTION OF THE PREFERRED EMBODIMENTS

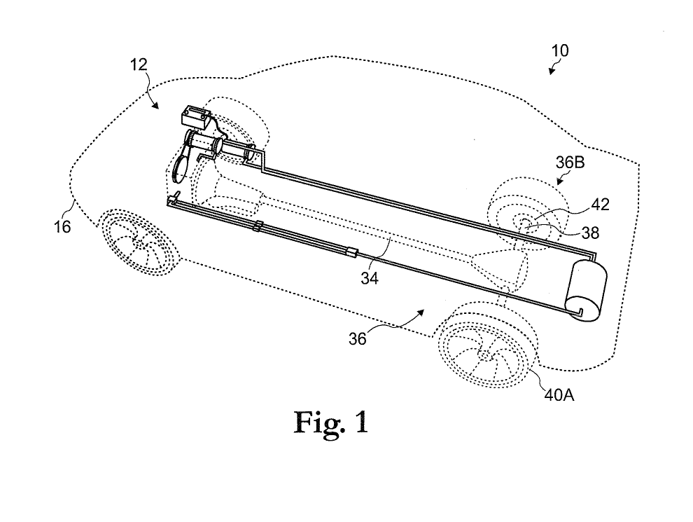

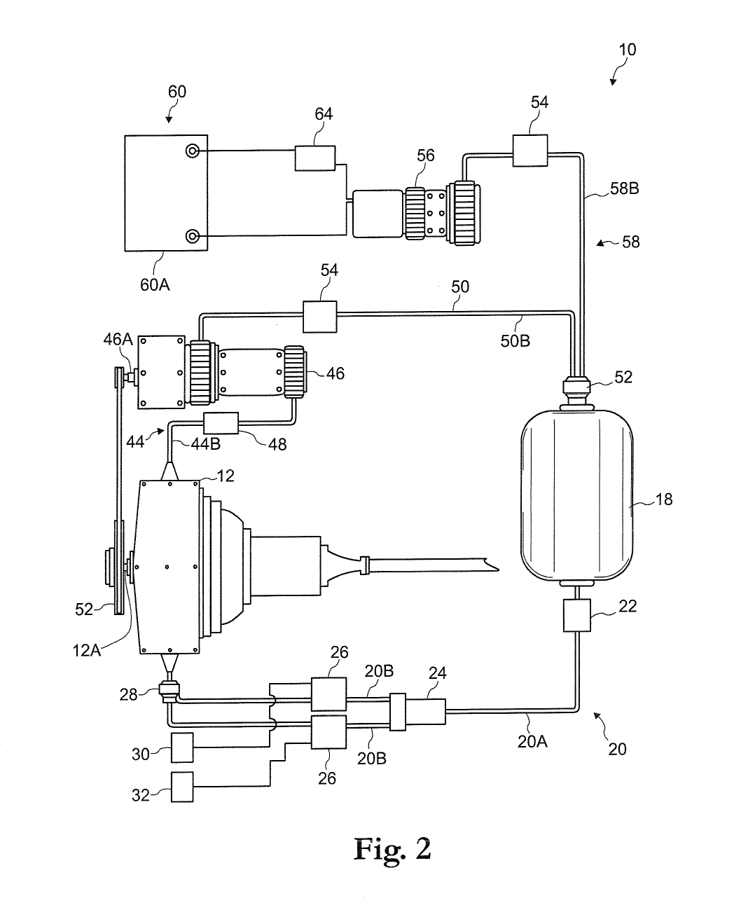

Referring to FIGS. 1 and 2, the compressed gas powered drive system 10 (hereinafter system 10) of the present invention is shown. The system 10 may use a turbine 12 as a power source. The rotation of the turbine 12 may be used to rotate a transaxle unit 34 of a vehicle 16 employing the system 10 thus driving the vehicle 16.

The turbine 12 may be coupled to storage tank 18. The storage tank 18 may be used to store a pressurized gas which may be used to rotate the turbine 12. The pressurized gas stored in the storage tank 18 may be sent to the turbine by one or more tubes 20. In accordance with one embodiment, the tubes 20 are high pressure lines 20A.

In accordance with one embodiment, a pressure regulator 22 may be positioned between the storage tank 18 and the tubes 20. The pressure regulator 22 may be used to control the flow of gas from the storage tank 18. In accordance with one embodiment, a high pressure line 20A runs from a pressure regulator 22 to a shutoff valve 24. The shutoff valve 24 may be used to close the high pressure line 24 and stop the flow of compressed gas from the storage tank 18. In the present embodiment, the shutoff valve 24 is an automated shutoff valve to act when a preset condition (such as a failure in the system 10) occurs.

The shutoff valve 24 may be connected to a pair of outlet high pressure lines 20B. In the present embodiment, each of the pair of outlet high pressure lines 20B may be coupled to a flow regulator 26. Each flow regulator 26 is used to control the flow of the pressurized gas in each of the pair of outlet high pressure lines 20B. The output of each flow regular 26 is then attached to a regulator 28. The regulator 28 controls the flow of the compressed gas flowing through the high pressure lines 20B to the turbine 12 to which outputs of the flow regulator 26 are attached.

One of the regulators 28 is coupled to the accelerator pedal 30. A second regulator 28 is coupled to the brake pedal 32. Thus, by pressing either the accelerator pedal 30 or the brake pedal 32, the user of the system 10 may control the flow of compressed gas flowing through the flow regulators 26 through the high pressure lines 20B to the turbine 12.

The turbine 12 may be coupled to a transaxle unit 34. The transaxle unit 34 may be a unit combining the transmission and differential and connected directly to axle assemblies 36. The axle assemblies 36 may be a straight axle or a split-axle design. In the embodiment shown in FIG. 1, a split-axle design is used. The split-axle design allows for independent suspension of the left and right wheels. A split axle further permits the use of a differential, allowing the left and right drive wheels to be driven at different speeds, improving traction and extending tire life.

The axle assembly 36 may have a front axle assembly (not shown) and a rear axle assembly 36B coupled to a main frame unit 33. The front axle assembly and rear axle assemblies may have a pair of output axle shafts 38 wherein each output axle shaft 38 has a first end which extends to a drive wheel 40A. In general, the drive wheel 40A may be coupled to a wheel hub 42 which may be formed on the first end of the output axle shaft 38. The output axle shaft 38 may be contained in respective non-rotating hollow, elongated axle arm sections which may be secured to the main frame unit. The second end of each output axle shaft 38 may be connected to the transaxle unit 34.

While the present embodiment shows rear wheel drive with the rear axle assembly 36B as the drive unit, this should not be seen in a limiting scope. The vehicle may be a front wheel drive vehicle with the front axle assembly as the drive unit. Further, the vehicle 10 may be a four wheel drive vehicle with the both the front and rear axle assemblies coupled to the transaxle unit 34 or by adding a second drive motor/transaxle assembly coupled to the front axle assembly.

An output tube 44 is coupled to the turbine 12. The output tube 44 captures the compressed gas that was injected into the turbine 12 causing the turbine 12 to rotate. The output tube 44 may be coupled to a compressor unit 46. The compressor unit 46 may take the captured compressed gas from the output tube 44 and repressurize the compressed gas. A recovery regulator valve 48 may be placed in the output tube 44 prior to the compressor unit 46. The recovery regulator valve 48 may be used to control the flow of the captured compressed gas flowing through the output tube 44. In accordance with one embodiment, the output tube 44 is a high pressure line 44B.

The compressor unit 46 may be coupled to an output shaft 12A of the turbine 12. The output shaft 12A may have a gear unit 52 attached to one end of the output shaft 12A. The gear unit 52 is coupled to a drive unit 46A of the compressor unit 46. In general, a drive belt is attached to the gear unit 52 and to the drive unit 46A of the compressor nit 46.

The repressurized compressed gas may then be sent back to the storage tank 18 via tubes 50. A flow regulator valve 52 may be positioned between the tube 50 and the storage tank 18. The flow regulator valve 52 may be used to control the flow of the repressurized compressed gas sent through the tubes 50 back to the storage tank 18. An output monitoring pressure gauge 54 may be placed in the tube 50. The output monitoring pressure gauge 54 is used to show the pressure of the repressurized compressed gas in the tube 50. In accordance with one embodiment, the tube 50 is a high pressure line 50B.

A second compressor unit 56 may be coupled to the flow regulator valve 52 via tubes 58. The second compressor unit 56 may be powered by a power source 60. The power source may be an AC or a DC power source. In the present embodiment, a batter 60A may be used to power the second compressor unit 56. A switch mechanism 64 may be positioned between the power source 60 and the second compressor unit 56. The switch mechanism 64 may be used to activate and deactivate the second compressor unit 56. In accordance with one embodiment, the tube 58 is a high pressure line 58B.

The second compressor unit 56 may be used to further repressurized the compressed gas in order to send the repressurized the compressed gas back to the storage tank 18. Another output monitoring pressure gauge 54 may be placed in the tube 62. The output monitoring pressure gauge 54 is used to show the pressure of the repressurized compressed gas in the tube 62.

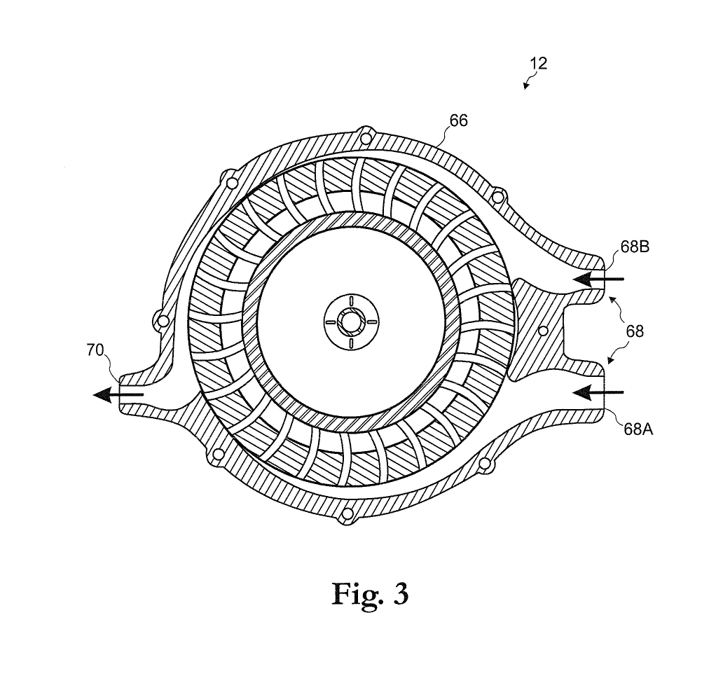

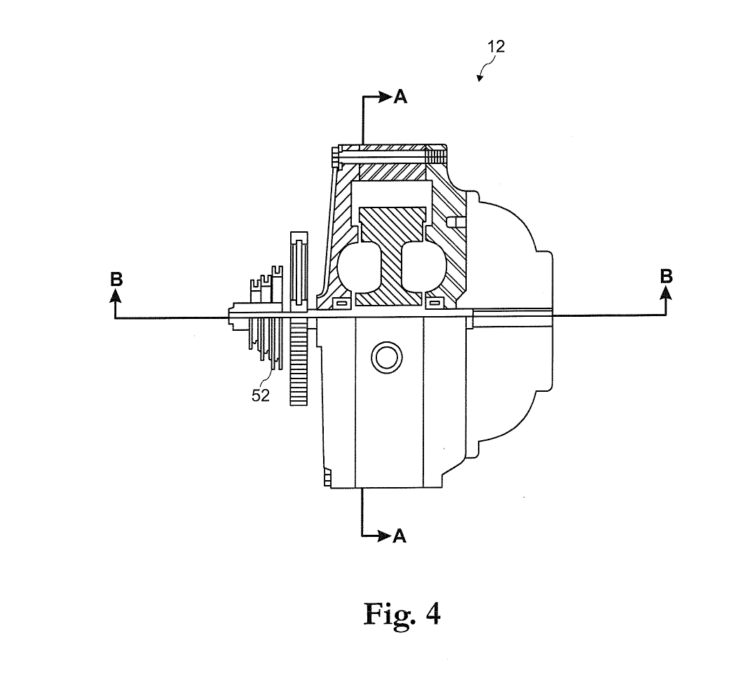

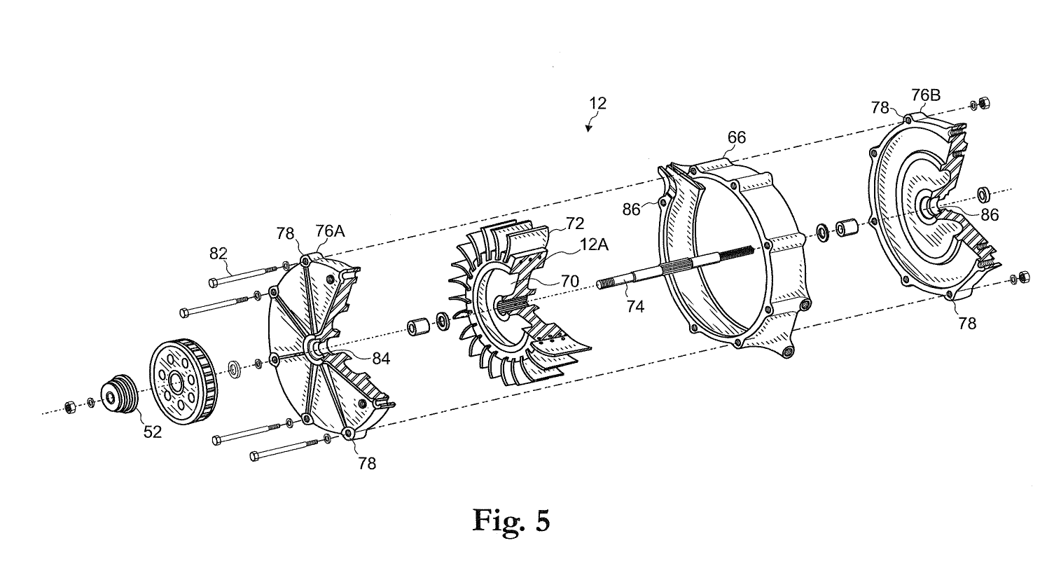

Referring now to FIGS. 3-5, the turbine 12 is shown in more detail. As shown, the turbine 12 is an enclosed unit. The turbine 12 has a housing 66. The housing 66 may be made out of different material. In accordance with one embodiment, the housing 66 is formed of a metal such as steel or the like. The housing 66 may have one or more input ports 68. In general, the housing may have two input ports 68A and 68B. The input port 68A is coupled to a first of the high pressure line 20B′. The input port 68A may be used to direct the compressed gas from the first of the high pressure line 20B to rotate a turbine unit 12A when the accelerator pedal 30 is pressed. The input port 68B may be coupled to a second of the high pressure line 20B. The input port 68B may be used to direct the compressed gas from the second of the high pressure line 20B to slow the rotation of the turbine unit 12 when the brake pedal 30 is pressed.

The housing 66 may further have an output port 70. In accordance with one embodiment, the output port 70 is in axial alignment with the input port 68A. Since the output port 70 is in axial alignment with the input port 68A, the compressed gas flowing through the turbine unit 12A has a more direct path through the turbine unit 12A.

The turbine unit 12A is located within the housing 66. The turbine unit 12A has a drum 70 which has a plurality of blades 72 attached thereto. The blades 72 may be used to catch the compressed gas being injected into the housing 66 and cause the turbine unit 12 to rotate. An axle unit 74 is attached to the drum 70. The axle unit 74 is centrally aligned through the drum 70 to allow the turbine unit 12A to smoothly rotate.

End plates 76A and 76B may be attached to side surfaces of the housing 66. The end plates 76A and 76B enclose the housing 66. The end plates 76A and 76B have a plurality of holes 78 formed around an outer perimeter thereof. The holes 78 may be in axial alignment with holes 80 formed in the housing 66. Screws 82 or other type of connectors may be inserted into the holes 78 to secure the end plates 76A and 76B to side surfaces of the housing 66.

The end plates 76A and 76B may each have a central opening 84. The central opening 84 may hold a bearing assembly 86. The bearing assembly 86 may allow the axle unit 74 to pass through and rotate about the central opening 84.

Attached to one end of the axle unit is a gear unit 52. The gear unit 52 may be coupled to the drive unit 46A of the compressor unit 46. In general, a drive belt is attached to the gear unit 52 and to the drive unit 46A of the compressor nit 46.

While embodiments of the disclosure have been described in terms of various specific embodiments, those skilled in the art will recognize that the embodiments of the disclosure can be practiced with modifications within the spirit and scope of the claims, and will also recognize that different features of different embodiments may be combined and incorporated into other embodiments.

What is claimed is:

1. A system for propelling a vehicle comprising:
an enclosed turbine unit coupled to a transaxle of the vehicle;
a storage tank holding a compressed gas, the compressed gas used to rotate a turbine of the turbine unit; and
a first compressor unit coupled to an output of the enclosed turbine unit to repressurize the compressed gas used to rotate the turbine and to send the repressurize compressed gas back to an input of the storage tank.

2. A system for propelling a vehicle in accordance with claim 1 further comprising a second compressor unit coupled to the input of the storage tank to repressurize the compressed gas used to rotate the turbine.

3. A system for propelling a vehicle in accordance with claim 1 wherein the first compressor unit is coupled to a gear unit of the enclosed turbine unit to power the first compressor unit.

4. A system for propelling a vehicle in accordance with claim 2 wherein the second compressor unit is coupled to a DC power source.

5. A system for propelling a vehicle in accordance with claim 1 further comprising:
a first regulator coupled to an output of the storage tank and to a first input of the enclosed turbine unit;
an accelerator deal coupled to the first regulator;
a second regulator coupled to the output of the storage tank and to a second input of the enclosed turbine unit; and
a brake pedal coupled to the second regulator.

6. A system for propelling a vehicle in accordance with claim 5 further comprising:
a high pressure line coupled to the output of the storage tank;
a valve unit coupled to the high pressure line;
an accelerator high pressure line coupled to the valve unit and the first input of the enclosed turbine unit, the first regulator positioned within the accelerator high pressure line;
a braking high pressure line coupled to the valve unit and the second input of the enclosed turbine unit, the second regulator positioned within the braking high pressure line.

7. A system for propelling a vehicle in accordance with claim 6 wherein the valve unit is a shutoff valve to close the high pressure line and stop the flow of compressed gas from the storage tank when a preset condition occurs.

8. A system for propelling a vehicle in accordance with claim 1 further comprising a pressure regulator valve coupled to an output of the storage tank.

9. A system for propelling a vehicle in accordance with claim 1 further comprising a recovery regulator valve coupled to an output of the enclosed turbine unit.

10. A system for propelling a vehicle in accordance with claim 1 further comprising a flow regulator valve coupled to the input of the storage tank.

11. A system for propelling a vehicle in accordance with claim 1 further comprising a first pressure gauge coupled between the first compressor unit and the storage tank.

12. A system for propelling a vehicle in accordance with claim 2 further comprising a second pressure gauge coupled between the second compressor unit and the storage tank.

13. A system for propelling a vehicle in accordance with claim 1 wherein the enclosed turbine unit comprises:
a housing having a first and second input port and an output port;
end plates attached to the housing to enclose the housing;
an opening centrally located in each end plate; and
an axle positioned through the opening in each end plate, the axle allowing the turbine to rotate.

14. A system for propelling a vehicle comprising:
an enclosed turbine unit coupled to a transaxle of the vehicle;
a storage tank holding a compressed gas, the compressed gas used to rotate a turbine of the turbine unit; and
a first compressor unit coupled to an output of the enclosed turbine unit to repressurize the compressed gas used to rotate the turbine and to send the repressurize compressed gas back to an input of the storage tank; and
a second compressor unit coupled to the input of the storage tank to repressurize the compressed gas used to rotate the turbine;
wherein the first compressor unit is coupled to a gear unit of the enclosed turbine unit to power the first compressor unit;
wherein the second compressor unit is coupled to a DC power source.

15. A system for propelling a vehicle in accordance with claim 14 further comprising:
a first regulator coupled to an output of the storage tank and to a first input of the enclosed turbine unit;
an accelerator deal coupled to the first regulator;
a second regulator coupled to the output of the storage tank and to a second input of the enclosed turbine unit; and
a brake pedal coupled to the second regulator.

16. A system for propelling a vehicle in accordance with claim 15 further comprising:
a high pressure line coupled to the output of the storage tank;
a valve unit coupled to the high pressure line;
an accelerator high pressure line coupled to the valve unit and the first input of the enclosed turbine unit, the first regulator positioned within the accelerator high pressure line;
a braking high pressure line coupled to the valve unit and the second input of the enclosed turbine unit, the second regulator positioned within the braking high pressure line.

17. A system for propelling a vehicle in accordance with claim 16 wherein the valve unit is a shutoff valve to close the high pressure line and stop the flow of compressed gas from the storage tank when a preset condition occurs.

18. A system for propelling a vehicle in accordance with claim 14 further comprising a pressure regulator valve coupled to an output of the storage tank.

19. A system for propelling a vehicle in accordance with claim 14 further comprising a recovery regulator valve coupled to an output of the enclosed turbine unit.

20. A system for propelling a vehicle in accordance with claim 14 further comprising a flow regulator valve coupled to the input of the storage tank.
